(19) United States
(12) Patent Application Publication
(10) Pub. No.: US 2023/0253603 A1
(43) Pub. Date: Aug. 10, 2023

(54) FASTENING JIG, FUEL CELL STACK-FASTENING JIG ASSEMBLY INCLUDING THE SAME, AND METHOD FOR FUEL CELL STACK

(71) Applicants: HYUNDAI MOTOR COMPANY, SEOUL (KR); KIA CORPORATION, SEOUL (KR)

(72) Inventors: Hyun Bae Dong, Seoul (KR); Yong Min Kim, Seoul (KR); Ju Hae Jung, Uiwang-si (KR); Sun Hee Jo, Suwon-si (KR)

(21) Appl. No.: 17/873,346

(22) Filed: Jul. 26, 2022

(30) Foreign Application Priority Data
Feb. 10, 2022 (KR) 10-2022-0017713

(51) Int. Cl. H01M 8/248; H01M 8/2404

(52) U.S. Cl. CPC H01M 8/248; H01M 8/2404

(57) ABSTRACT

A fastening jig for fastening a pair of end plates provided on opposite sides of a cell stack body, in which a plurality of unit cells are stacked along a stacking direction includes a first insertion part inserted into a first insertion recess formed in any one of the end plates such that movement thereof in the stacking direction and an opposite direction thereto is restricted, an extension part extending from the first insertion part along the stacking direction, and a second insertion part extending from a distal end of the extension part in the stacking direction, inserted into a second insertion recess formed in the other one of the end plates, and configured to press the other one of the end plates.

### CROSS REFERENCE TO RELATED APPLICATIONS

This application claims the benefit of priority to Korean Patent Application No. 10-2022-0017713, filed in the Korean Intellectual Property Office on Feb. 10, 2022, the entire contents of which are incorporated herein by reference.

### TECHNICAL FIELD

The present disclosure relates to a fastening jig, a fuel cell stack-fastening jig assembly including the same, and a method for assembling a fuel cell stack.

### BACKGROUND

In general, a fuel cell stack includes a cell stack body, in which a plurality of cells are stacked along a stacking direction, and end plates are positioned on opposite sides of the cell stack body. The end plates may function to support and fix the cell stack body.

Conventionally, when the fuel cell stack is manufactured, a scheme of pressing the end plates and the cell stack body at a specific fastening pressure and then fixing the fastening jig and the end plates by using bolts has been used. The scheme requires a process of fastening the fastening jig and the bolt, a work time for assembling the stack is increased, and productivity is decreased.

### SUMMARY

The present disclosure has been made to solve the above-mentioned problems occurring in the prior art while advantages achieved by the prior art are maintained intact.

An aspect of the present disclosure provides a fastening jig, by which a work time for assembling a stack is shortened, a fuel cell stack-fastening jig assembly including the same, and a method for assembling the fuel cell stack.

The technical problems to be solved by the present disclosure are not limited to the aforementioned problems, and any other technical problems not mentioned herein will be clearly understood from the following description by those skilled in the art to which the present disclosure pertains.

According to another aspect of the present disclosure, a fastening jig for fastening a pair of end plates provided on opposite sides of a cell stack body, in which a plurality of unit cells are stacked along a stacking direction includes a first insertion part inserted into a first insertion recess formed in any one of the end plates such that movement thereof in the stacking direction and an opposite direction thereto is restricted, and an extension part extending from the first insertion part along the stacking direction.

In another embodiment, the fastening jig may further include a second insertion part extending from a distal end of the extension part in the stacking direction, inserted into a second insertion recess formed in the other one of the end plates, and configured to press the other one of the end plates.

In another embodiment, the first insertion part may include a first insertion area extending from a distal end of the extension part in the opposite direction to the stacking direction, in a direction crossing the stacking direction, and a second insertion area extending from a distal end of the first insertion area, in the stacking direction, and inserted into the first insertion recess.

In another embodiment, the first insertion part may further include a third insertion area extending from a distal end of the second insertion area, in the direction crossing the stacking direction, and inserted into the first insertion recess.

In another embodiment, the extension part may be formed to be elastically deformed.

In another embodiment, the second insertion part may include a first insertion area extending from a distal end of the extension part in the stacking direction, in a direction crossing the stacking direction, and a second insertion area extending from a distal end of the first insertion area, in the opposite direction to the stacking direction, and inserted into the second insertion recess.

In another embodiment, the first insertion part, the extension part, and the second insertion part may be integrally formed.

According to another aspect of the present disclosure, a fuel cell stack-fastening jig assembly includes a cell stack body including a plurality of cells stacked along a stacking direction, a pair of end plates disposed in the stacking direction of the cell stack body and an opposite direction thereto, respectively, and a fastening jig configured to restrict movement of the pair of end plates in the stacking direction and the opposite direction, any one of the pair of end plates includes a first insertion recess configured such that a first insertion part corresponding to one end of the fastening jig is inserted thereinto, and movement of the first insertion part inserted into the first insertion recess in the stacking direction and the opposite direction is restricted.

According to another aspect of the present disclosure, a method for assembling a fuel cell stack includes disposing a cell stack body between a pair of end plates arranged along a stacking direction, pressing one of the pair of end plates, which is located in a stacking direction, in an opposite direction to the stacking direction, and pressing one of the pair of end plates, which is located in the opposite direction to the stacking direction, in the stacking direction, and coupling a fastening jig to the pair of end plates, any one of the pair of end plates includes a first insertion recess having a shape that is recessed inwards, and a first insertion part is formed at one end of the fastening jig, and in the coupling of the fastening jig to the pair of end plates, the first insertion part of the fastening jig is inserted into the first insertion recess such that movement thereof in the stacking direction and the opposite direction is restricted.

In another embodiment, the coupling of the fastening jig to the pair of end plates may include inserting the first insertion part into the first insertion recess, and inserting a second insertion part formed at an opposite end of the fastening jig into a second insertion recess of the other one of the pair of end plates.

In another embodiment, the method may further include stopping pressing of the pair of end plates.

### BRIEF DESCRIPTION OF THE FIGURES

The above and other objects, features and advantages of the present disclosure will be more apparent from the following detailed description taken in conjunction with the accompanying drawings:

FIG. 1 is a view illustrating end plates and a cell stack body, to which a fastening jig according to an embodiment of the present disclosure may be applied;

FIG. 2 is a view conceptually illustrating a fastening jig according to an embodiment of the present disclosure;

FIG. 3 is a view illustrating a state, in which a fastening jig according to an embodiment of the present disclosure is coupled to end plates;

FIG. 4 is a view illustrating a state, in which a pressing operation has been performed in FIG. 1;

FIG. 5 is a view conceptually illustrating a state, in which a first insertion operation is performed; and

FIG. 6 is a view conceptually illustrating a state after the first insertion operation has been performed.

### DETAILED DESCRIPTION

Hereinafter, some embodiments of the present disclosure will be described in detail with reference to the exemplary drawings. In providing reference numerals to the constituent elements of the drawings, the same elements may have the same reference numerals even if they are displayed on different drawings. Further, in the following description of the present disclosure, a detailed description of known functions and configurations incorporated herein will be omitted when it may make the subject matter of the present disclosure rather unclear.

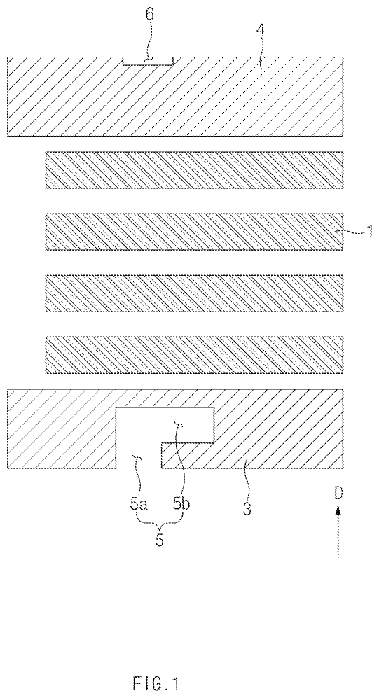

A fastening jig according to an embodiment of the present disclosure may be a fastening jig for fastening a pair of end plates 3, 4. The pair of end plates 3, 4 may be provided on opposite side of a cell stack body 1, in which a plurality of unit cells are stacked in a stacking direction “D”. FIG. 1 is a view illustrating the end plates and the cell stack body, to which the fastening jig according to an embodiment of the present disclosure may be applied. FIG. 1, the stacking direction “D” may refer to an upward direction.

As an example, the cell may include a membrane-electrode assembly (MEA). The membrane-electrode assembly may include a solid polymeric electrode membrane, through which hydrogen ions may flow, and a cathode and an anode that are electrode layers obtained by applying a catalyst on opposite surfaces of the electrolyte membrane such that hydrogen and oxygen may react with each other.

In an outer part of the membrane-electrode assembly, that is, in an outer part, in which the cathode and anode are located, gas diffusion layers (GDL) may be stacked, and on an outside of the gas diffusion layer, bipolar plates each having a flow field, through which a reaction gas is supplied and cooling water passes, may be located.

Further, a gasket for sealing a fluid and the like may be stacked between the bipolar plates. The gasket may be provided in a state, in which it is integrally injection-molded in the membrane-electrode assembly or the bipolar plates or is formed as a separate solid gasket.

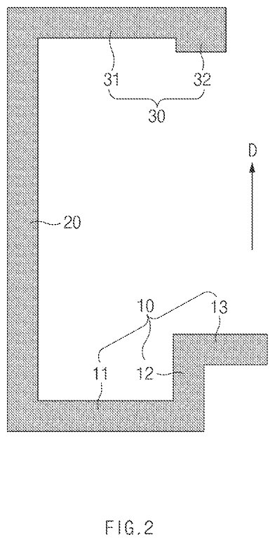

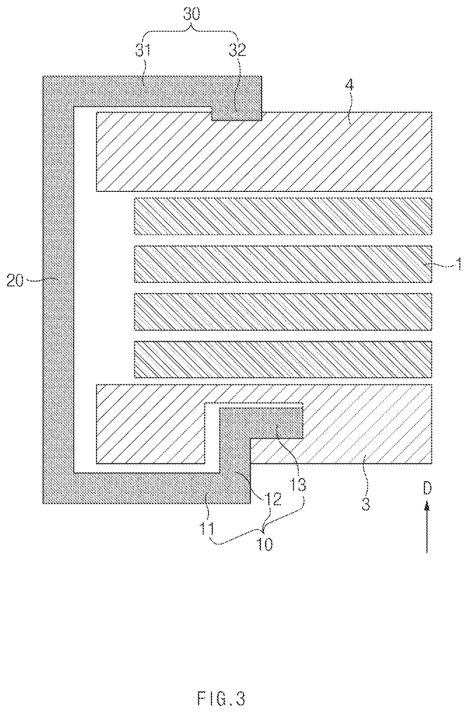

FIG. 2 is a view conceptually illustrating the fastening jig according to an embodiment of the present disclosure. FIG. 3 is a view illustrating a state, in which the fastening jig according to an embodiment of the present disclosure is coupled to end plates.

As illustrated in FIG. 2, the fastening jig may include a first insertion part 10 and an extension part 20.

The first insertion jig 10 may be inserted into a first insertion recess 5 formed on any one of the end plates 3, 4, and here shown on end plate 3. The first insertion part 10 may be inserted into the first insertion recess 5 such that movement thereof in the stacking direction “D” and an opposite direction thereto may be restricted.

The extension part 20 may extend from the first insertion part 10 along the stacking direction “D”. The extension part 20 may be formed to be elastically deformable.

The fastening jig may include a second insertion part 30. The first insertion part 10, the extension part 20, and the second insertion part 30 may be integrally formed. However, the present disclosure is not limited thereto, and all or some thereof may be provided separately.

The second insertion part 30 may extend from a distal end of the extension part 20 in the stacking direction “D”, and may be inserted into the second insertion recess 6 formed in the other one of the end plates 3, 4, and here shown in end plate 4. The second insertion part 30 may be inserted into a second insertion recess 6 and may press the other one of the end plates 3, 4.

According to the present disclosure, because the pair of end plates 3, 4 are fastened without using a bolt in a form, in which the first insertion part 10 is inserted into the first insertion recess 5, a work process of fastening a bolt may be deleted, and thus a work time for assembling may be reduced and productivity may be increased. Hereinafter, a detailed shape of the first insertion part 10 for achieving the effects will be described below.

The first insertion part 10 may include a first insertion area 11 and a second insertion area 12. The first insertion area 11 may extend from a distal end of the extension part 20 in the opposite direction to the stacking direction “D” in a direction that crosses the stacking direction “D”. As an example, the first insertion area 11 may extend perpendicularly to the extension part 20.

The second insertion area 12 may extend from a distal end of the first insertion area 11 in the stacking direction “D”. For example, a shape viewed when the first insertion area 11 and the second insertion area 12 are viewed together, may be a substantially “L” shape. The second insertion area 12 may be inserted into the first insertion recess 5.

The first insertion part 10 may further include a third insertion area 13. The third insertion area 13 may extend from a distal end of the second insertion area 13 in the direction that crosses the stacking direction “D”. For example, a shape viewed when the second insertion area 12 and the third insertion area 13 are viewed together, may be a substantially “L” shape. The third insertion area 13 may be inserted into the first insertion recess 5.

Meanwhile, as the third insertion area 13 is inserted into the first insertion recess 5, movement thereof in the stacking direction “D” and the opposite direction thereto may be restricted. As an example, the first insertion recess 5 may include a first part 5a and a second part 5b. The first part 5a may be a part that is recessed in the stacking direction “D” in any one of the end plates 3. The first part 5a may correspond to a shape of the second insertion area 12.

The second part 5b may be a part that is recessed to cross the first part 5a from the distal end of the first part 5a in the stacking direction “D”. The second part 5b may correspond to a shape of the third insertion area 13. The first insertion recess 5 may have a substantially “L” shape. As illustrated in FIG. 3, when the third insertion area 13 is inserted into the second part 5b, a part of any one of the end plates 13, which hinders movement of the third insertion area 13 in the stacking direction “D” and the opposite direction thereto, is present, and thus movement thereof in the stacking direction “D” and the opposite direction thereto may be restricted.

The second insertion part 30 may include a first insertion area 31 and a second insertion area 32. The first insertion area 31 may extend from a distal end of the extension part 20 in the stacking direction “D” in a direction that crosses the stacking direction “D”. As an example, the first insertion area 31 may be perpendicular to the extension part 20. The second insertion area 32 may extend from a distal end of the first insertion area 31 in the opposite direction to the stacking direction “D”. The second insertion area 32 may be inserted into the second insertion recess 6.

### Fuel Cell Stack-Fastening Jig Assembly

Hereinafter, contents on the fuel cell stack-fastening jig assembly will be described below based on the above-described contents on the fastening jig. The contents on the fastening jig have been described above, and thus a detailed description thereof will be omitted.

The fuel cell stack-fastening jig assembly including the fastening jig according to an embodiment of the present disclosure may include the cell stack body 1, the end plates 3, 4, and the fastening jig. The cell stack body 1 may include the plurality of cells stacked along the stacking direction “D”. The end plates 3, 4 may be disposed in the stacking direction “D” of the cell stack body 1 and the opposite direction thereto, respectively. The pair of end plates 3, 4 may be provided. Any one end plate of the pair of end plates 3, 4 may include the first insertion recess 5. The first insertion part 10, which corresponds to one end of the fastening jig, may be inserted into the first insertion recess 5.

The fastening jig may restrict movement of the pair of end plates 3, 4 in the stacking direction “D” and the opposite direction thereto. For example, as movement of the first insertion part 10 inserted into the first insertion recess 5 in the stacking direction “D” and the opposite direction thereto is restricted, movement of the pair of end plates 3, 4 in the stacking direction “D” and the opposite direction thereto may be restricted.

### Method for Assembling Fuel Cell Stack

Hereinafter, the method for assembling the fuel cell stack including the fastening jig according to an embodiment of the present disclosure will be described below based on the above-described contents. The contents on the fastening jig and the fuel cell stack-fastening jig assembly have been described above, and thus a detailed description thereof will be omitted.

The method for assembling the fuel cell stack according to an embodiment of the present disclosure may include a disposition operation, a pressing operation, and a fastening operation. The disposition operation may be an operation of disposing the cell stack body 1 between the pair of end plates 3, 4 arranged in the stacking direction “D”. This may be understood as the state of FIG. 1.

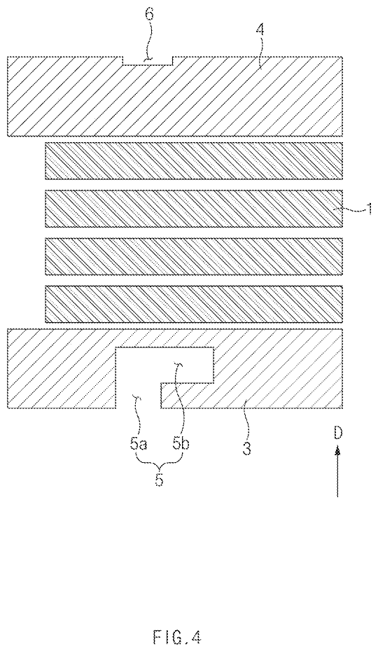

The pressing operation may be an operation of pressing one of the pair of end plates, which is located in a stacking direction “D”, in an opposite direction to the stacking direction “D”, and pressing the other one of the pair of end plates, which is located in the opposite direction to the stacking direction “D”, in the stacking direction “D”. FIG. 4 is a view illustrating a state, in which the pressing operation has been performed in FIG. 1.

The fastening operation may be an operation of coupling a fastening jig to the pair of end plates 3, 4. In the fastening operation, the first insertion part 10 of the fastening jig may be inserted into the first insertion recess 5 such that movement thereof in the stacking direction “D” and an opposite direction thereto may be restricted.

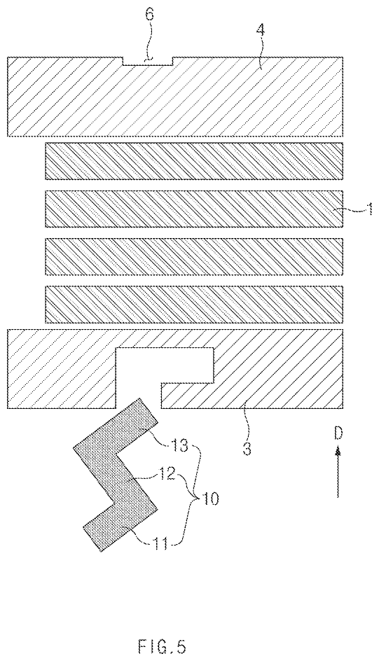

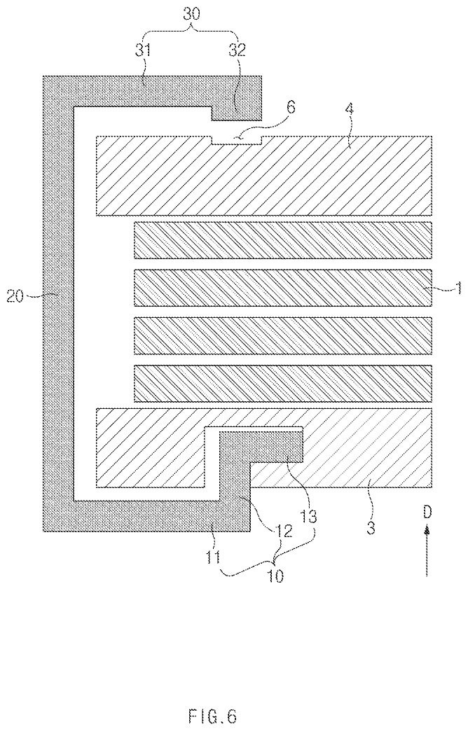

As an example, the fastening operation may include a first insertion operation and a second insertion operation. The first insertion operation may be an operation of inserting the first insertion part 10 into the first insertion recess 5. FIG. 5 is a view conceptually illustrating a state, in which the first insertion operation is performed. For reference, for convenience of illustration, the extension part 20 and the second insertion part 30 are omitted in FIG. 5. FIG. 6 is a view conceptually illustrating a state after the first insertion operation has been performed.

The second insertion operation may be an operation of inserting the second insertion part 30 formed at an opposite end of the fastening jig into the second insertion recess 6 of the other end plate 3, 4 of the pair of end plates.

The method for assembling the fuel cell stack according to an embodiment of the present disclosure may further include a press releasing operation. The press releasing operation may be an operation of stopping pressing of the pair of end plates 3, 4. This may be understood as a state, in which the state of FIG. 6 is changed to the state of FIG. 3.

According to the present disclosure, because a work process of fastening a bolt is not included, a work time for assembling may be reduced and thus productivity may be increased.

According to the present disclosure, because the pair of end plates are fastened without using a bolt in a form, in which the insertion part is inserted into the insertion recess, a work process of fastening a bolt may be deleted, and thus a work time for assembling may be reduced and productivity may be increased.

The above description is a simple exemplification of the technical spirits of the present disclosure, and the present disclosure may be variously corrected and modified by those skilled in the art to which the present disclosure pertains without departing from the essential features of the present disclosure. Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the technical scope of the present disclosure should be construed by the attached claims, and all the technical spirits within the equivalent ranges fall within the scope of the present disclosure.

1. A fastening jig for fastening a pair of end plates provided on opposite sides of a cell stack body, in which a plurality of unit cells are stacked along a stacking direction, the fastening jig comprising:
a first insertion part inserted into a first insertion recess formed in one of the pair of end plates, such that movement of the first insertion part in the stacking direction and a direction opposite to the stacking direction is restricted; and
an extension part extending from the first insertion part along the stacking direction.

2. The fastening jig of claim 1, further comprising:
a second insertion part extending from a distal end of the extension part in the stacking direction, the second insertion part configured to be inserted into a second insertion recess formed in an other one of the pair of end plates, and configured to press the other one of the pair of end plates.

3. The fastening jig of claim 1, wherein the first insertion part includes:
a first insertion area extending from a distal end of the extension part in the opposite direction to the stacking direction, in a direction crossing the stacking direction; and
a second insertion area extending from a distal end of the first insertion area, in the stacking direction, and inserted into the first insertion recess.

4. The fastening jig of claim 3, wherein the first insertion part further includes:
a third insertion area extending from a distal end of the second insertion area, in the direction crossing the stacking direction, and inserted into the first insertion recess.

5. The fastening jig of claim 1, wherein the extension part is configured to be elastically deformed.

6. The fastening jig of claim 2, wherein the second insertion part includes:
a first insertion area extending from a distal end of the extension part in the stacking direction, in a direction crossing the stacking direction; and
a second insertion area extending from a distal end of the first insertion area of the second insertion part, in the opposite direction to the stacking direction, and inserted into the second insertion recess.

7. The fastening jig of claim 2, wherein the first insertion part, the extension part, and the second insertion part are integrally formed.

8. A fuel cell stack-fastening jig assembly comprising:
a cell stack body including a plurality of cells stacked along a stacking direction;
a pair of end plates, wherein one of the pair of end plates is positioned in the stacking direction of the cell stack body, and an other of the pair of end plates is positioned in a direction opposite to the stacking direction; and
a fastening jig configured to restrict movement of the pair of end plates in the stacking direction and the opposite direction;
wherein one of the pair of end plates includes:
a first insertion recess configured such that a first insertion part corresponding to one end of the fastening jig is inserted into the first insertion recess; and
wherein movement of the first insertion part inserted into the first insertion recess in the stacking direction and the opposite direction is restricted.

9. A method for assembling a fuel cell stack, the method comprising:
positioning a cell stack body between a pair of end plates arranged along a stacking direction;
pressing one of the pair of end plates, which is located in a stacking direction, in an opposite direction to the stacking direction, and pressing an other one of the pair of end plates, which is located in the opposite direction to the stacking direction, in the stacking direction; and
coupling a fastening jig to the pair of end plates;
wherein one of the pair of end plates includes a first insertion recess having a shape that is recessed inwards, and a first insertion part is formed at one end of the fastening jig; and
wherein in the coupling of the fastening jig to the pair of end plates, the first insertion part of the fastening jig is inserted into the first insertion recess such that movement thereof in the stacking direction and the opposite direction is restricted.

10. The method of claim 9, wherein the coupling of the fastening jig to the pair of end plates includes:
inserting the first insertion part into the first insertion recess; and
inserting a second insertion part formed at an opposite end of the fastening jig into a second insertion recess of the other one of the pair of end plates.

11. The method of claim 9, further comprising:
stopping pressing of the pair of end plates.
